(19) United States
(12) Patent Application Publication
(10) Pub. No.: US 2010/0102276 A1
(43) Pub. Date: Apr. 29, 2010

(54) PHOSPHOR FOR ULTRAVIOLET EXCITED LIGHT-EMITTING DEVICE, PHOSPHOR PASTE, AND ULTRAVIOLET EXCITED LIGHT-EMITTING DEVICE

(75) Inventors: Satoru Kuze, Tsukuba-shi (JP); Yoshiko Nakamura, Higashimurayama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY ,LIMITED, Chuo-ku ,Tokyo (JP)

(21) Appl. No.: 12/530,173

(22) PCT Filed: Feb. 27, 2008
(86) PCT No.: PCT/JP2008/053894

§ 371 Date: Oct. 1, 2009

(30) Foreign Application Priority Data
Mar. 9, 2007 (JP) 2007-059821

(51) Int. Cl. C09K 11/67; C09K 11/66; C09K 11/59; C09K 11/55

(52) U.S. Cl. 252/301.4 F

(57) ABSTRACT

The present invention provides a phosphor for an ultraviolet excited light-emitting device, a phosphor paste and an ultraviolet excited light-emitting device. A phosphor for an ultraviolet excited light-emitting device, the phosphor comprising an oxide containing M¹, M² and M³ as a matrix and an activator, wherein M¹ represents at least one element selected from the group consisting of Ba, Sr and Ca, M² represents at least two elements selected from the group consisting of Ti, Zr and Hf, and M³ represents at least one element selected from the group consisting of Si and Ge.

### TECHNICAL FIELD

The present invention relates to a phosphor for an ultraviolet excited light-emitting device, a phosphor paste, and an ultraviolet excited light-emitting device.

### BACKGROUND ART

An ultraviolet excited light-emitting device contains a phosphor that is excited by ultraviolet ray irradiation to emit light. The ultraviolet excited light-emitting device can include a light-emitting device which is excited with an ultraviolet ray having a wavelength of a range of 200 to 350 nm, and a light-emitting device which is excited with an ultraviolet ray having a wavelength of a range of 100 to 200 nm (which is sometimes referred to as a vacuum ultraviolet excited light-emitting device). The former is, for example, a back light for a liquid Crystal display, a three-wavelength type fluorescent lamp or a high-load fluorescent lamp. The latter is, for example, a plasma display panel or a rare gas lamp.

Japanese Patent Application Laid-open (JP-A) No. 2006-2043 Gazette discloses a phosphor for a vacuum ultraviolet excited light-emitting device, the phosphor being represented by the formula of Ba_{0.98}ZrSi₃O₉:Eu_{0.02}.

However, the phosphor disclosed in the Gazette does not exhibit sufficient emission brightness under ultraviolet ray irradiation, and also the emission wavelength exhibiting the maximum emission intensity in the emission spectrum (the spectrum showing a relationship between the emission wavelength and the emission intensity) is too long, so Oat the phosphor is insufficient for use in a light-emitting device.

### DISCLOSURE OF THE INVENTION

An object of the present invention is to provide a phosphor that exhibits higher emission brightness under ultraviolet ray irradiation and in which the emission wavelength exhibiting the maximum emission intensity in the emission spectrum is shorter, thereby being suitable for an ultraviolet excited light-emitting device.

The present inventors have made eager studies in order to solve the problems and have reached the present invention. Namely, the present invention provides the following <1> to <8>.

<1> A phosphor for an ultraviolet excited light-emitting device, the phosphor comprising an oxide containing M¹, M² and M³ as a matrix and an activator, wherein M¹ represents at least one element selected from the group consisting of Ba, Sr and Ca, M² represents at least two elements selected from the group consisting of Ti, Zr and Hf, and M³ represents at least one element selected from the group consisting of Si and Ge.
<2> The phosphor according to <1>, wherein the oxide is represented by the formula (1),

aM¹O.bM²O₂.cM³O₂ (1)

in the formula (1),

0.5≦a≦1.5,

0.5≦b≦1.5, and

2≦c≦4.

<3> The phosphor according to <1> or <2>, wherein the activator is Eu.
<4> The phosphor according to any one of <1> to <3>, wherein M² contains Ti.
<5> A phosphor for an ultraviolet excited light-emitting device, the phosphor being represented by the formula (2),

(M⁴₁₋ₓEuₓ)(Ti_{1-y}Zr_{y})Si₃O₉ (2)

in the formula (2), M⁴ represents at least one element selected from the group consisting of Ba, Sr and Ca,

0.0001≦x≦0.5, and

0.8≦y<1.

<6> A phosphor paste comprising a phosphor according to any one of <1> to <5>.
<7> A phosphor layer being obtained by a method comprising a step of applying the phosphor paste according to <6> to a substrate, and then subjecting the phosphor paste to heat treatment.
<8> An ultraviolet excited light-emitting device comprising a phosphor according to any one of <1> to <5>.

### BRIEF DESCRIPTION OF THE DRAWINGS

FIG. 1 shows an X-ray diffraction pattern of phosphor 1.

FIG. 2 shows an X-ray diffraction pattern of phosphor 2.

FIG. 3 shows an X-ray diffraction pattern of phosphor 3.

FIG. 4 shows an X-ray diffraction pattern of phosphor 4.

FIG. 5 shows an X-ray diffraction pattern of phosphor 5.

FIG. 6 shows an X-ray diffraction pattern of phosphor 6.

### BEST MODES FOR CARRYING OUT THE INVENTION

### Phosphor

The phosphor of the present invention comprises an oxide containing M¹, M² and M³.

M¹ represents Ba, Sr and/or Ca. These may be used alone or in combination with each other. M² represents a combination of Ti and Zr, a combination of Ti and Hf, a combination of Zr and Hf, or a combination of Ti, Zr and Hf. M³ represents Si and/or Ge. These may be used alone or in combination with each other.

The phosphor further comprises an activator.

Since the phosphor comprises the oxide as the matrix and the activator, the phosphor emits light under ultraviolet ray irradiation. In more detail, the phosphor emits light under ultraviolet ray irradiation, since a part of the elements constituting the matrix is substituted by an element as the activator. The element as the activator is Eu, Ce, Pr, Nd, Sm, Tb, Dy, Er, Tm, Yb, Bi and/or Mn. These may be used alone or in combination with each other.

In the phosphor, from the viewpoint of enhancing the emission brightness, the oxide containing M¹, M² and M³, is preferably represented by the formula (1).

In the phosphor, from the viewpoint of enhancing the emission brightness, the activator preferably contains Eu. It is preferable that the ratio of the divalent Eu ions be higher. When the activator contains Eu, the emission brightness will be further higher by substituting a part of Eu with a coactivator. The coactivator contains Al, Sc, Y, La, Gd, Co, Pr, Nd, Pm, Sm, Tb, Dy, Ho, Er, Tm, Yb, Lu, Bi, Au, Ag, Cu and/or Mn. These may be used alone or in combination with each other. The ratio of substitution is generally 50 mol % or less of Eu.

From the viewpoint of further enhancing the emission brightness, the phosphor preferably contains Ti, more preferably Ti and Zr, as M².

The present invention also provides a phosphor represented by the formula (2).

In the formula (2), x is 0.0001 or more and 0.5 or less. From the viewpoint of the balance between the emission brightness and the production cost, x is preferably 0.001 or more and 0.1 or less.

In the formula (2), y is 0.8 or more and less than 1. From the viewpoint of enhancing the emission brightness, y is preferably 0.85 or more and less than 1, more preferably 0.9 or more and 0.995 or less. In the formula (2), Eu is the activator.

The phosphor generally has a crystal structure of a benitoite type. The crystal structure is identified by the X-ray diffraction method.

The phosphor may be produced by a method comprising calcining a mixture of metal compounds containing a composition that can become a phosphor by calcining and the like. Generally, the phosphor may be produced by weighing and mixing compounds containing metal elements so that a predetermined composition can be attained, to obtain a mixture and then calcining the mixture.

For example, the phosphor represented by the formula of Ba_{0.98}Ti_{0.01}Zr_{0.99}Si₃O₉:Eu_{0.02} may be produced by weighing BaCO₃, TiO₂, ZrO₂, SiO₂ and Eu₂O₃ so that a molar ratio of Ba:Ti:Zr:Si:Eu can be 0.98:0.01:0.99:3:0.02, mixing them to obtain a mixture and then calcining the mixture.

The compounds containing metal elements may be, for example, compounds of Ba, Sr, Ca, Ti, Zr, Hf, Si, Ge, Eu, Al, Sc, Y, La, Gd, Ce, Pr, Nd, Pm, Sm, Tb, Dy, Ho, Er, Tm, Yb, Lu, Bi, Au, Ag, Cu and Mn. These may be oxide or a compound that can be decomposed and/or oxidized at a high temperature to become oxide, such as hydroxide, carbonate, nitrate, halide or oxalate.

The compounds containing metal elements may contain a halogen-containing compound (flux) such as fluoride or chloride. The use of such a compound can increase the degree of crystallinity of the phosphor to be obtained and can increase the average particle size of the phosphor to be obtained. The flux may be, for example, LiF, NaF, KF LiCl, NaCl, KCl, Li₂CO₃, Na₂CO₃, K₂CO₃, NaHCO₃, NH₄Cl, NH₄I, MgF₂, CaF₂, SrF₂, BaF₂, MgCl₂, CaCl₂, SrCl₂, BaCl₂, MgI₂, CaI₂, SrI₂ and BaI₂.

The mixing may be carried out by using an apparatus generally used industrially, such as a ball mill, a V-type mixer or a stirrer. The mixing may be carried out either by a dry method or a wet method.

The compounds containing metal elements may be prepared by the crystallization method.

If the metal compound mixture contains a compound that can be decomposed and/or oxidized at a high temperature, such as hydroxide, carbonate, nitrate, halide or oxalate, precalcination may be carried out. The precalcination may be carried out, for example, under the conditions of a temperature of about 400° C. to about 1600° C. and an atmosphere of an inert gas, an oxidizing gas or a reducing gas. By the precalcination, the mixture may be turned into oxide, and the crystal water is removed. After the precalcination, the calcination may be carried out. Also, after the precalcination, grinding may be carried out.

The calcination may be carried out, for example, under the conditions of a temperature of about 600° C. to about 1600° C., preferably about 1200° C. to about 1500° C., and a holding time of about 0.5 to about 100 hours. In the case of producing the phosphor represented by the formula (2), the calcining temperature is preferably about 1200° C. to about 1500° C. The calcination is preferably carried out in an inert gas atmosphere such as nitrogen or argon, an oxidizing atmosphere such as air, oxygen, oxygen-containing nitrogen or oxygen-containing argon, or a reducing atmosphere such as hydrogen-containing nitrogen containing about 0.1 vol % to about 10 vol % of hydrogen, or hydrogen-containing argon containing about 0.1 vol % to about 10 vol % of hydrogen. In the case of calcination in a strongly reducing atmosphere, a suitable amount of carbon may be added to the metal compound mixture. The calcination may be carried out two or more times.

The phosphor may be ground, for example, with use of a ball mill or a jet mill, and may be washed or classified. The phosphor may be subjected to surface treatment. The surface treatment may be carried out by a method of coating the particle surface of the phosphor with an inorganic substance containing Si, Al, Ti, Y and the like.

### Phosphor Paste

The phosphor paste of the present invention contains the phosphor and an organic substance as major components.

The organic substance can include a solvent and a binder. The phosphor paste can be used in the same manner as the phosphor paste used in the production of a conventional light-emitting device. By removing the organic substance in the phosphor paste by volatilization, combustion or decomposition by means of heat treatment, a phosphor layer substantially comprising a phosphor can be obtained.

The phosphor paste may be produced, for example, by the method disclosed in Japanese Patent Application Laid-open (JP-A) No. 10-255671 Gazette. The phosphor paste can be obtained by mixing the phosphor, a binder, and a solvent with a ball mill, a triple roll and the like.

The binder may be, for example, a cellulose-based resin (ethylcellulose, methylcellulose, nitrocellulose, acetylcellulose, cellulose propionate, hydroxypropylcellulose, butylcellulose, benzylcellulose, denatured cellulose and the like), acryl-based resin (polymer of at least one kind among the monomers such as acrylic acid, methacrylic acid, methyl acrylate, methyl methacrylate, ethyl acrylate, ethyl methacrylate, propyl acrylate, propyl methacrylate, isopropyl acrylate, isopropyl methacrylate, n-butyl acrylate, n-butyl methacrylate, tert-butyl acrylate, tert-butyl methacrylate, 2-hydroxyethyl acrylate, 2-hydroxyethyl methacrylate, 2-hydroxypropyl acrylate, 2-hydroxypropyl methacrylate, benzyl acrylate, benzyl methacrylate, phenoxy acrylate, phenoxy methacrylate, isobornyl acrylate, isobornyl methacrylate, glycidyl methacrylate, styrene, α-methylstyreneacrylamide, methacrylamide, acrylonitrile, methacrylonitrile and the like), ethylene-vinyl acetate copolymer resin, polyvinylbutyral, polyvinyl alcohol, propylene glycol, polyethylene oxide, urethane-based resin, melamine-based resin or phenolic resin.

The solvent may be, for example, a monohydric alcohol having a higher boiling point, a polyhydric alcohol such as diol or triol represented by ethylene glycol or glycerin, or a compound obtained by etherizing and/or esterizing an alcohol (ethylene glycol monoalkyl ether, ethylene glycol dialkyl ether, ethylene glycol alkyl ether acetate, diethylene glycol monoalkyl ether acetate, diethylene glycol dialkyl ether, propylene glycol monoalkyl ether, propylene glycol dialkyl ether, propylene glycol alkyl acetate).

The phosphor layer obtained by subjecting the phosphor paste to a substrate, and then subjecting the phosphor paste to heat treatment, is excellent in moisture resistance. The substrate is made of such a material as glass or resin. The substrate may be flexible, and the shape is a plate, a container and the like. The application may be carried out, for example, by a screen printing method or an ink jet method. The heat treatment may be carried out generally under a condition of about 300° C. to about 600° C. After the application, the substrate may be dried under a condition of room temperature (about 25° C.) to about 300° C. before the heat treatment.

### Ultraviolet Excited Light-Emitting Device

The ultraviolet excited light-emitting device of the present invention comprises the phosphor, and generally comprises the phosphor, electrodes and a discharge space. The discharge space may be a space in which an excitation light of the phosphor can be generated when a voltage is applied, and generally a rare gas and the like are enclosed therein.

A plasma display panel which is one of the ultraviolet excited light-emitting device containing a phosphor will be described. The plasma display panel may be produced, for example, by the method disclosed in Japanese Patent Application Laid-open (JP-A) No. 10-195428 Gazette. When the phosphor exhibits a blue emission, a green phosphor, a red phosphor, and the blue phosphor are respectively mixed with a binder comprising a cellulose-based resin and a solvent comprising polyvinyl alcohol, and phosphor pastes are prepared. The phosphor pastes are applied by such a method as a screen printing method to a stripe-shaped substrate surface and to a separation wall surface, the substrate being partitioned by a separation wall, the substrate being provided with an address electrode, and the substrate being located at an inner surface of the back surface substrate, followed by heat treatment at 300° C. to 600° C. to obtain respective phosphor layers. To the phosphate layer, a surface glass substrate provided with a transparent electrode and a bus electrode in a direction perpendicular to the phosphor layers, and provided with a dielectric substance layer and a protective layer disposed on an inner surface, is superposed and bonded. The inside is evacuated, and a low-pressure rare gas such as Xe or Ne is enclosed therein to form a discharge space, and whereby a plasma display panel is obtained.

A high-load fluorescent lamp (a small-scale fluorescent lamp having a large consumption electric power per unit area of the tube wall of the lamp) which is another one of an ultraviolet excited light-emitting device comprising a phosphor will be described. The high-load fluorescent lamp may be produced, for example, by the method disclosed in Japanese Patent Application Laid-open (JP-A) No. 10-251636 Gazette. When the phosphor exhibits a blue emission, a mixture of a green phosphor, a red phosphor, and the blue phosphor is dispersed into an aqueous solution of polyethylene oxide and the like to prepare a phosphor paste. The phosphor paste is applied to an inner wall of a glass tube, and is dried, followed by heat treatment at about 300° C. to about 600° C. to obtain a phosphor layer. A filament is attached to the glass tube, and then such ordinary steps as evacuation are carried out, and a low-pressure rare gas such as Ar, Kr or Ne and mercury are enclosed therein and a ferrule is attached to form a discharge space, and whereby a high-load fluorescent lamp is obtained.

### EXAMPLES

The present invention will be described in more detail by way of Examples. The crystal structure of a phosphor was determined by the powder X-ray diffraction method using an X-ray diffraction measurement apparatus (RINT2500TTR type, manufactured by Rigaku Co., Ltd., characteristic X-ray of CuKα).

### Reference Example 1

### Production of Phosphor

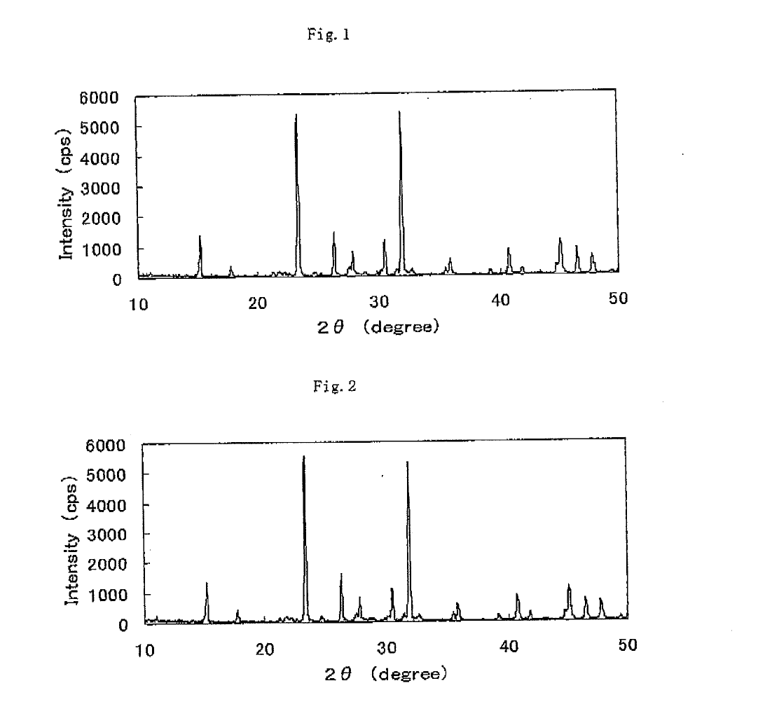

Barium carbonate (manufactured by Nippon Chemical Industry Co., Ltd.: having a purity of 99% or more), zirconium oxide (manufactured by Wako Pure Chemical Industry Co., Ltd.: having a purity of 99.99%), silicon dioxide (manufactured by Nippon Aerosyl Co., Ltd.: having a purity of 99.99%), and europium oxide (manufactured by Shin-etsu Chemical Co., Ltd.: having a purity of 99.99%) were weighed so that the molar ratio of Ba:Zr:Si:Eu would be 0.98:1:3:0.02, and were mixed for 4 hours by a dry-type ball mill to obtain a mixture. The mixture was put on an alumina boat, and was calcined at 1300° C. for 5 hours in a nitrogen atmosphere to obtain a phosphor 1 represented by the formula of Ba_{0.98}ZrSi₃O₉:Eu_{0.02}. The X-ray diffraction pattern of the phosphor 1 is shown in FIG. 1. As shown in FIG. 1, the phosphor 1 had a crystal structure of benitoite type.

### Emission Brightness by 146 nm Excitation

The emission obtained by irradiating a vacuum ultraviolet ray to the phosphor 1 under 6.7 Pa (5×10⁻² Torr) or less and at room temperature (about 25° C.) in a vacuum tank using an excimer 146 nm lamp (manufactured by Ushio Electric Co., Ltd., H0012 type) was evaluated by using a spectroradiometer (SR-3 manufactured by Topcon Co., Ltd.). In regard to the emission, the emission wavelength showing the maximum emission intensity was 480 nm. The emission brightness at this time was set to be 100. The emission brightness by 146 nm excitation was shown as a relative brightness assuming that the emission brightness of the phosphor 1 was 100. The result was shown in Table 1.

### Emission Brightness by 172 nm Excitation

The emission obtained by irradiating a vacuum ultraviolet ray to the phosphor 1 under 6.7 Pa (5×10⁻² Torr) or less and at room temperature (about 25° C.) in a vacuum tank using an excimer 172 nm lamp (manufactured by Ushio electric Co., Ltd., H0016 type) was evaluated by using a spectroradiometer (SR-3 manufactured by Topcon Co., Ltd.). In regard to the emission, the emission wavelength showing the maximum emission intensity was 480 nm. The emission brightness at this time was set to be 100. The emission brightness by 172 nm excitation was shown as a relative brightness assuming that the emission brightness of the phosphor 1 was 100. The result was shown in Table 2.

### Emission Brightness by 254 nm Excitation

An ultraviolet ray having a wavelength of 254 nm was irradiated to the phosphor 1 under an ordinary pressure and at room temperature with a spectrofluorescence photometer (manufactured by Nippon Spectroscopy Co., Ltd., FP-6500 type). In regard to the emission, the emission wavelength showing the maximum emission intensity was 480 nm. The emission brightness at this time was set to be 100. The emission brightness of the phosphor by 254 nm excitation was shown as a relative brightness assuming that the emission brightness of the phosphor 1 was 100. The result was shown in Table 3.

### Example 1

Barium carbonate (manufactured by Nippon Chemical Industry Co., Ltd.: having a purity of 99% or more), titanium oxide (manufactured by High Purity Chemical Institute Co., Ltd.: having a purity of 99.9%), zirconium oxide (manufactured by Wako Pure Chemical Industry Co., Ltd.: having a purity of 99.99%), silicon dioxide (manufactured by Nippon Aerosyl Co., Ltd.: having a purity of 99.99%), and europium oxide (manufactured by Shin-etsu Chemical Co., Ltd.: having a purity of 99.99%) were weighed so that the molar ratio of Ba:Ti:Zr:Si:Eu would be 0.98:0.005:0.995:3:0.02, and were mixed for 4 hours by a dry-type ball mill to obtain a mixture. The mixture was put on an alumina boat, and was calcined at 1300° C. for 5 hours in a nitrogen gas atmosphere to obtain a phosphor 2 represented by the formula of Ba_{0.98}Ti_{0.005}Zr_{0.995}Si₃O₉:Eu_{0.02}. The X-ray diffraction pattern of the phosphor 2 was shown in FIG. 2. As shown in FIG. 2, the phosphor 2 had a crystal structure of benitoite type.

The phosphor 2 was evaluated under the same condition as that of [Emission brightness by 146 nm excitation], [Emission brightness by 172 nm excitation], and [Emission brightness by 254 nm excitation] in the Reference Example 1. The respective results were shown in Table 1, Table 2, and Table 3.

### Example 2

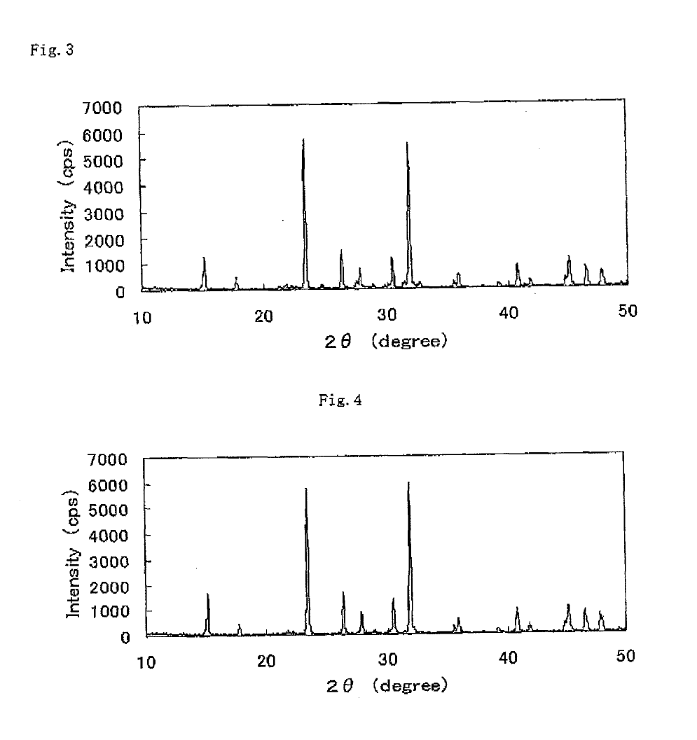

Barium carbonate (manufactured by Nippon Chemical Industry Co., Ltd.: having a purity of 99% or more), titanium oxide (Manufactured by High Purity Chemical Institute Co., Ltd.: having a purity of 99.9%), zirconium oxide (manufactured by Wako Pure Chemical Industry Co., Ltd.: having a purity of 99.99%), silicon dioxide (manufactured by Nippon Aerosyl Co., Ltd.: having a purity of 99.99%), and europium oxide (manufactured by Shin-etsu Chemical Co., Ltd.: having a purity of 99.99%) were weighed so that the molar ratio of Ba:Ti:Zr:Si:Eu would be 0.98:0.01:0.99:3:0.02, and were mixed for 4 hours by a dry-type ball mill to obtain a mixture. The mixture was put on an alumina boat, and was calcined at 1300° C. for 5 hours in a nitrogen gas atmosphere to obtain a phosphor 3 represented by the formula of Ba_{0.98}Ti_{0.01}Zr_{0.99}Si₃O₅:Eu_{0.02}. The X-ray diffraction pattern of the phosphor 3 was shown in FIG. 3, As shown in FIG. 3, the phosphor 3 had a crystal structure of benitoite type.

The phosphor 3 was evaluated under the same condition as that of [Emission brightness by 146 nm excitation], [Emission brightness by 172 nm excitation], and [Emission brightness by 254 nm excitation] in the Reference Example 1. The respective results were shown in Table 1, Table 2, and Table 3.

### Example 3

Barium carbonate (manufactured by Nippon Chemical Industry Co., Ltd.: having a purity of 99% or more), titanium oxide (manufactured by High Purity Chemical Institute Co., Ltd.: having a purity of 99.9%), zirconium oxide (manufactured by Wako Pure Chemical Industry Co., Ltd.: having a purity of 99.99%), silicon dioxide (manufactured by Nippon Aerosyl Co., Ltd.: having a purity of 99.99%), and europium oxide (manufactured by Shin-etsu Chemical Co., Ltd.: having a purity of 99.99%) were weighed so that the molar ratio of Ba:Ti:Zr:Si:Eu would be 0.98:0.1:0.9:3:0.02, and were mixed for 4 hours by a dry-type ball mill to obtain a mixture. The mixture was put on an alumina boat, and was calcined at 1300° C. for 5 hours in a nitrogen gas atmosphere to obtain a phosphor 4 represented by the formula of Ba_{0.98}Ti_{0.1}Zr_{0.9}Si₃O₉:Eu_{0.02}. The X-ray diffraction pattern of the phosphor 4 was shown in FIG. 4. As shown in FIG. 4, the phosphor 4 had a crystal structure of benitoite type.

The phosphor 4 was evaluated under the same condition as that of [Emission brightness by 146 nm excitation], [Emission brightness by 172 nm excitation], and [Emission brightness by 254 nm excitation] in the Reference Example 1. The respective results were shown in Table 1, Table 2, and Table 3.

### Example 4

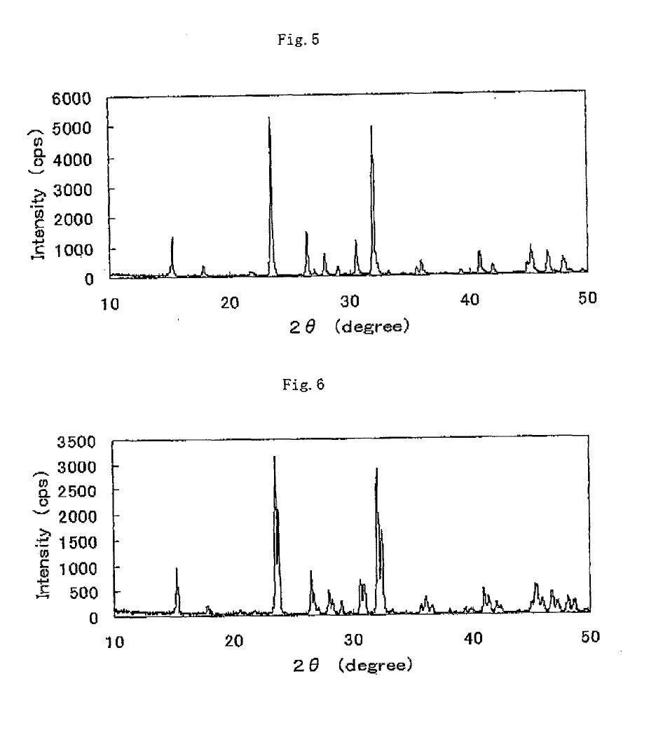

Barium carbonate (manufactured by Nippon Chemical Industry Co., Ltd.: having a purity of 99% or more), titanium oxide (manufactured by High Purity Chemical Institute Co., Ltd.: having a purity of 99.9%), zirconium oxide (manufactured by Wako Pure Chemical Industry Co., Ltd.: having a purity of 99.99%), silicon dioxide (manufactured by Nippon Aerosyl Co., Ltd.: having a purity of 99.99%), and europium oxide (manufactured by Shin-etsu Chemical Co., Ltd.: having a purity of 99.99%) were weighed so that the molar ratio of Ba:Ti:Zr:Si:Eu would be 0.98:0.25:0.75:3:0.02, and were mixed for 4 hours by a dry-type ball mill to obtain a mixture. The mixture was put on an alumina boat, and was calcined at 1300° C. for 5 hours in a nitrogen gas atmosphere to obtain a phosphor 5 represented by the formula of Ba_{0.98}Ti_{0.25}Zr_{0.75}Si₃O₉:Eu_{0.02}. The X-ray diffraction pattern of the phosphor 5 was shown in FIG. 5. As shown in FIG. 5, the phosphor 5 had a crystal structure of benitoite type.

The phosphor 5 was evaluated under the same condition as that of [Emission brightness by 254 nm excitation] in the Reference Example 1. The results were shown in Table 3.

### Example 5

Barium carbonate (manufactured by Nippon Chemical Industry Co., Ltd.: having a purity of 99% or more), titanium oxide (manufactured by High Purity Chemical Institute Co., Ltd.: having a purity of 99.9%), zirconium oxide (manufactured by Wake Pure Chemical Industry Co., Ltd.: having a purity of 99.99%), silicon dioxide (manufactured by Nippon Aerosyl Co., Ltd.: having a purity of 99.99%), and europium oxide (manufactured by Shin-etsu Chemical Co., Ltd.: having a purity of 99.99%) were weighed so that the molar ratio of Ba:Ti:Zr:Si:Eu would be 0.98:0.5:0.5:3:0.02, and were mixed for 4 hours by a dry-type ball mill to obtain a mixture. The mixture was put on an alumina boat, and was calcined at 1300° C. for 5 hours in a nitrogen gas atmosphere to obtain a phosphor 6 represented by the formula of Ba_{0.98}Ti_{0.5}Zr_{0.5}Si₃O₉:Eu_{0.02}. The X-ray diffraction pattern of the phosphor 6 was shown in FIG. 6. As shown in FIG. 6, the phosphor 6 had a crystal structure of benitoite type.

The phosphor 6 was evaluated under the same condition as that of [Emission brightness by 254 nm excitation] in the Reference Example 1. The results were shown in Table 3.

As shown in Tables 1 to 3, the phosphor of the present invention is more suitably used for a light-emitting device which is excited with the ultraviolet ray having a wavelength of a range of 200 nm to 350 nm as the 254 nm excited light-emitting device, when compared with a' light-emitting device which is excited with the ultraviolet ray having a wavelength of a range of 100 nm to 200 nm as the 146 nm excited light-emitting device and the 172 nm excited light-emitting device.

In Tables 1 to 3, the wavelength of the maximum emission means the emission wavelength exhibiting the maximum emission intensity.

TABLE 1
Emission brightness of phosphor by 146 nm excitation

| | | | Wavelength |
|---|---|---|---|
| | | | of maximum |
| | | Relative | emission |
| | | brightness | by 146 nm |
| | | by 146 nm | excitation |
| | composition | excitation | (nm) |
| phosphor 1 | Ba_{0.98}ZrSi₃O₉:Eu_{0.02} | 100 | 480 |
| phosphor 2 | Ba_{0.98}Zr_{0.995}Ti_{0.005}Si₃O₉:Eu_{0.02} | 131 | 473 |
| phosphor 3 | Ba_{0.98}Zr_{0.99}Ti_{0.01}Si₃O₉:Eu_{0.02} | 136 | 468 |
| phosphor 4 | Ba_{0.98}Zr_{0.9}Ti_{0.1}Si₃O₉:Eu_{0.02} | 121 | 445 |

TABLE 2
Emission brightness of phosphor by 172 nm excitation

| | | | Wavelength |
|---|---|---|---|
| | | | of maximum |
| | | Relative | emission |
| | | brightness | by 172 nm |
| | | by 172 nm | excitation |
| | composition | excitation | (nm) |
| phosphor 1 | Ba_{0.98}ZrSi₃O₉:Eu_{0.02} | 100 | 480 |
| phosphor 2 | Ba_{0.98}Zr_{0.995}Ti_{0.005}Si₃O₉:Eu_{0.02} | 143 | 470 |
| phosphor 3 | Ba_{0.98}Zr_{0.99}Ti_{0.01}Si₃O₉:Eu_{0.02} | 151 | 462 |
| phosphor 4 | Ba_{0.98}Zr_{0.9}Ti_{0.1}Si₃O₉:Eu_{0.02} | 146 | 445 |

TABLE 3
Emission brightness of phosphor by 254 nm excitation

| | | | Wavelength |
|---|---|---|---|
| | | | of |
| | | | maximum |
| | | Relative | emission |
| | | brightness | by 254 nm |
| | | by 254 nm | excitation |
| | composition | excitation | (nm) |
| phosphor 1 | Ba_{0.98}ZrSi₃O₉:Eu_{0.02} | 100 | 480 |
| phosphor 2 | Ba_{0.98}Zr_{0.995}Ti_{0.005}Si₃O₉:Eu_{0.02} | 428 | 447 |
| phosphor 3 | Ba_{0.98}Zr_{0.99}Ti_{0.01}Si₃O₉:Eu_{0.02} | 402 | 447 |
| phosphor 4 | Ba_{0.98}Zr_{0.9}Ti_{0.1}Si₃O₉:Eu_{0.02} | 375 | 448 |
| phosphor 5 | Ba_{0.98}Zr_{0.75}Ti_{0.25}Si₃O₉:Eu_{0.02} | 281 | 445 |
| phosphor 6 | Ba_{0.98}Zr_{0.5}Ti_{0.5}Si₃O₉:Eu_{0.02} | 151 | 444 |

### INDUSTRIAL APPLICABILITY

The phosphor of the present invention exhibits higher emission brightness when an ultraviolet ray is irradiated, and can exhibit the shorter emission wavelength exhibiting the maximum emission intensity in the emission spectrum. Therefore, the phosphor is sufficiently usable for a light-emitting device, and is suitable for an ultraviolet excited light-emitting device, particularly for an ultraviolet excited light-emitting device which is excited with an ultraviolet ray having a wavelength of a range of 200 to 350 nm, specifically for a light-emitting device such as a back light for a liquid crystal display, a three-wavelength type fluorescent lamp or a high-load fluorescent lamp.

1. A phosphor for an ultraviolet excited light-emitting device, the phosphor comprising an oxide containing M¹, M² and M³ as a matrix and an activator, wherein M¹ represents at least one element selected from the group consisting of Ba, Sr and Ca, M² represents at least two elements selected from the group consisting of Ti, Zr and Hf, and M³ represents at least one element selected from the group consisting of Si and Ge.

2. The phosphor according to claim 1, wherein the oxide is represented by the formula (1),
aM¹O.bM²O₂.cM³O₂ (2)
in the formula (1),
0.5≦a≦1.5,
0.5≦b≦1.5, and
2≦c≦4.

3. The phosphor according to claim 1, wherein the activator is Eu.

4. The phosphor according to claim 1, wherein M² contains Ti.

5. A phosphor for an ultraviolet excited light-emitting device, the phosphor being represented by the formula (2),
(M⁴₁₋ₓEuₓ)(Ti_{1-y}Zr_{y})Si₃O₉ (2)
in the formula (2), M⁴ represents at least one element selected from the group consisting of Ba, Sr and Ca,
0.0001≦x≦0.5, and
0.8≦y<1.

6. A phosphor paste comprising the phosphor according to claim 1.

7. A phosphor layer being obtained by a method comprising a step of applying the phosphor paste according to claim 6 to a substrate, and then subjecting the phosphor paste to heat treatment.

8. An ultraviolet excited light-emitting device comprising the phosphor according to claim 1.
